(19) United States
(12) Patent Application Publication
(10) Pub. No.: US 2026/0208694 A1
(43) Pub. Date: Jul. 23, 2026

(54) Vehicle Management Arrangement and Vehicle Management Method

(71) Applicant: Bayerische Motoren Werke Aktiengesellschaft, Muenchen (DE)

(72) Inventors: Matthias FINK, Muenchen (DE); Thomas Nachbar, Poing (DE)

(21) Appl. No.: 19/381,056

(22) Filed: Nov. 6, 2025

(30) Foreign Application Priority Data
Nov. 20, 2024 (DE) 10 2024 134 128.9

(51) Int. Cl. B60R 25/24; B60R 25/04; B60W 50/14; G07C 9/00

(52) U.S. Cl. CPC B60R 25/24; B60R 25/04; B60W 50/14; G07C 9/00309; B60R 2025/0415; B60W 2050/146; B60W 2556/45; G07C 2009/00793

(57) ABSTRACT

A vehicle management arrangement includes a vehicle manufacturer backend device configured for generating, managing and distributing encrypted immobilizer tokens and unlock PINs, each immobilizer token being configured to release an immobilizer of a vehicle when the corresponding unlock PIN is entered, a vehicle manager backend device configured for communication with the vehicle manufacturer backend device for receiving and forwarding the encrypted immobilizer tokens and the unlock PINs to a vehicle manager terminal, a vehicle equipped with a control device for receiving the encrypted immobilizer tokens from the vehicle manufacturer backend device and/or the vehicle manager backend device, and for decrypting the immobilizer tokens after entry of the unlock PIN to release the immobilizer.

### CROSS REFERENCE TO RELATED APPLICATION

This application claims priority under 35 U.S.C. §119 from German Patent Application No. DE 10 2024 134 128.9, filed November 20, 2024, the entire disclosure of which is herein expressly incorporated by reference.

### BACKGROUND AND SUMMARY

The present disclosure relates to a vehicle management arrangement and a vehicle management method.

The manual handover of physical keys for vehicles is a major operational challenge, especially in the context of the modern car rental industry. This traditional method is associated with several disadvantages that affect both the efficiency and the security of the rental process.

One problem arises e.g. with the physical handover of keys to a large number of service employees responsible for various services such as cleaning, fuelling, maintenance and/or inspections. Each of these employees needs access to the vehicle, requiring the keys to be constantly exchanged. This practice leads to further delays, increased coordination effort and a higher likelihood of key loss or misunderstandings.

In addition, the use of physical keys poses significant security risks. The loss or theft of keys can have serious consequences, including the need to replace locks, resulting in additional costs and logistical challenges. Moreover, physical key management is prone to human error, which can affect the security of the entire system.

Another problem is the lack of flexibility in the operating procedure, as physical key handover requires personnel to be continually present. In times of digital technologies and the increasing customer demand for self-service options, this approach is not only outdated but also a competitive disadvantage.

These issues highlight the need for an improved method for managing rental car access that both increases operational efficiency and minimizes security risks by reducing dependence on physical keys and at the same time providing greater ease of use.

An object of the present disclosure can be seen as that of providing an improved vehicle management arrangement and an improved vehicle management method.

This object is achieved by a vehicle management arrangement and by a vehicle management method, according to the independent claims.

Accordingly, there is provision for:

a vehicle management arrangement, comprising a vehicle manufacturer backend device configured for generating, managing and distributing encrypted immobilizer tokens and unlock PINs, each immobilizer token being configured to release an immobilizer of a vehicle when the corresponding unlock PIN is entered; a vehicle manager backend device configured for communication with the vehicle manufacturer backend device for receiving and forwarding the encrypted immobilizer tokens and the unlock PINs to a vehicle manager terminal; a vehicle equipped with a control device for receiving the encrypted immobilizer tokens from the vehicle manufacturer backend device and/or the vehicle manager backend device and for decrypting the immobilizer tokens after entry of the unlock PIN to release the immobilizer.

A vehicle management method is also provided, comprising the following steps: a vehicle manufacturer backend device generating encrypted immobilizer tokens and unlock PINs, each immobilizer token being configured to release an immobilizer of the vehicle when the corresponding unlock PIN is entered; the vehicle manufacturer backend device managing and distributing the encrypted immobilizer tokens and unlock PINs to a vehicle manager backend device; forwarding the encrypted immobilizer tokens and unlock PINs from the vehicle manager backend device to a vehicle manager terminal; a control device of the vehicle receiving the encrypted immobilizer tokens from the vehicle manufacturer backend device and/or the vehicle manager backend device; a user of the vehicle entering the unlock PIN; the control device decrypting the immobilizer token after entry of the corresponding unlock PIN; the control device releasing the immobilizer of the vehicle after successful decryption of the immobilizer token.

The vehicle management arrangement comprises multiple components that work closely together to provide an efficient and secure system for managing vehicle access and use. One component of this vehicle management arrangement is the vehicle manufacturer backend device. This device is configured specifically to generate, manage and distribute encrypted immobilizer tokens and unlock PINs. An immobilizer token is a digital security mechanism that serves as a key for releasing an immobilizer of a vehicle. This token is encrypted to ensure system security and prevent unauthorized access. The unlock PIN is a personal identification code that is required in order to decrypt the immobilizer token and deactivate the immobilizer of the vehicle. The vehicle manufacturer backend device ensures that these tokens and PINs are securely generated and managed before being forwarded to other system components.

Another important component of the vehicle management arrangement is the vehicle manager backend device. This vehicle manager backend device communicates directly with the vehicle manufacturer backend device to receive the encrypted immobilizer tokens and unlock PINs. Once these have been received, the vehicle manager backend device forwards them securely to a vehicle manager terminal. The vehicle manager terminal serves as an interface for the vehicle manager to gain access to the required immobilizer tokens and unlock PINs and, if necessary, distribute them to the vehicles. This communication between the backend devices ensures that the tokens and PINs are always up to date and synchronized to ensure the security and integrity of the vehicle management arrangement.

The vehicle itself is another component of this vehicle management arrangement. The vehicle is equipped with a control device capable of receiving the encrypted immobilizer tokens from the vehicle manufacturer backend device and/or the vehicle manager backend device. This control device is configured to decrypt the immobilizer tokens after the correct unlock PIN has been entered. As soon as the immobilizer token is successfully decrypted, the immobilizer of the vehicle is deactivated, allowing the vehicle to be started and used. This process ensures that only authorized persons can use the vehicle, as the combination of immobilizer token and unlock PIN is required in order to bypass the security lock.

The method of operation of the present disclosure is based on a secure, multi-step authentication method. First, the vehicle manufacturer backend device generates the necessary immobilizer tokens and unlock PINs, and distributes them securely to the vehicle manager backend device. From there, the data are transmitted to the vehicle, where they are stored and processed in the control device. When an authorized user enters the unlock PIN using an appropriate user interface, the control device decrypts the immobilizer token. This decrypted immobilizer token then releases the immobilizer of the vehicle so that the engine can be started. This process ensures that the vehicle can be used only by persons who possess and correctly use both the immobilizer token and the related unlock PIN.

The vehicle manufacturer backend device is a component of the vehicle management arrangement that is configured to generate, manage and distribute the basic security data for the vehicles. This device is configured specifically to generate encrypted immobilizer tokens and unlock PINs that are used to control vehicle access and use. The vehicle manufacturer backend device ensures that these security data are securely generated and stored before being forwarded to other systems or devices. It plays a crucial role in the security architecture of the vehicle management arrangement by ensuring that only authorized data are transferred to the vehicles and other systems.

The vehicle manager backend device is another component within the vehicle management arrangement. It acts as a communication interface between the vehicle manufacturer backend device and the vehicles themselves. This device is configured to receive the immobilizer tokens and unlock PINs generated and managed by the vehicle manufacturer backend device and to forward them securely to the appropriate vehicles. In addition, the vehicle manager backend device can undertake management and control of the vehicles within a fleet by monitoring and controlling access to and use of the vehicles. It allows vehicle managers to maintain a central overview of all vehicles and their security status, which is of great advantage particularly in scenarios such as fleet management.

The immobilizer token is a digital security mechanism that has been developed specifically to control access to and use of a vehicle. This immobilizer token is encrypted to ensure that it cannot be decrypted or tampered with by unauthorized persons. The immobilizer token is configured to release the immobilizer of a vehicle when it has been correctly decrypted using the unlock PIN. The immobilizer token is generated by the vehicle manufacturer backend device and can be sent to the appropriate vehicle using the vehicle manager backend device.

The unlock PIN is a personal identification number that is necessary in order to decrypt the immobilizer token and deactivate the immobilizer of the vehicle. This unlock PIN is generated by the vehicle manufacturer backend device and used in combination with the immobilizer token to ensure that only authorized persons gain access to and can use the vehicle. The unlock PIN can be entered by the user using a user interface on the vehicle. It provides an additional layer of security because the immobilizer token cannot be decrypted without the correct PIN. The PIN is also preferably transmitted in encrypted form and is configured to further increase the security of the vehicle.

The immobilizer is a security-related component within the vehicle that e.g. prevents the engine from starting as long as the immobilizer token has not been correctly decrypted. The immobilizer is controlled by the control device of the vehicle, which processes the immobilizer token and the unlock PIN. Only if both elements are correct and authorized is the immobilizer deactivated so that e.g. the engine can be started. The immobilizer thus forms the physical security barrier that prevents unauthorized use of the vehicle.

The vehicle manager terminal is a special unit or a piece of software that is used by the vehicle managers to undertake management and control of the vehicles. This terminal receives the immobilizer tokens and unlock PINs forwarded by the vehicle manager backend device and makes them available to the vehicles. It serves as an interface that the vehicle manager can use to manage access to the vehicles by monitoring and controlling the distribution of the security data. The vehicle manager terminal allows managers to monitor the status of vehicles in real time and take security measures when required.

The vehicle manager is the person or team responsible for managing and controlling the vehicle fleet. This role involves monitoring the vehicle state, managing the security data and ensuring that only authorized persons gain access to the vehicles. The vehicle manager uses the vehicle manager terminal and the backend devices to coordinate and implement the necessary security measures. This role is crucial for the smooth operation of a vehicle fleet, especially in commercial or rental-based scenarios, where efficient management and protection of the vehicles is of great importance.

The control device in the vehicle is a component that is configured for processing the security data. The control device receives the encrypted immobilizer tokens and unlock PINs from the vehicle manufacturer backend device and/or the vehicle manager backend device. The control device decrypts the immobilizer token after entry of the correct unlock PIN and deactivates the immobilizer so that the vehicle can be started or used. The control device plays a central role in the vehicle management arrangement, as it is the last instance authorizing or denying use of the vehicle. The incorporation of the control device in the vehicle ensures that the safety mechanisms operate at the highest level and that the vehicle is protected from unauthorized access.

The technical advantages of the vehicle management arrangement according to the present disclosure are manifold. First, the vehicle management arrangement provides a high level of security through the use of encrypted immobilizer tokens and unlock PINs that release the immobilizer of the vehicle only in combination. This encryption prevents unauthorized persons from being able to start the vehicle even if they have physical access to the vehicle. Second, the vehicle management arrangement allows flexible and central management of vehicle access by the vehicle manager backend device, which is advantageous particularly in fleet management scenarios. Third, digitizing and automating the access process improves efficiency and ease of use, as physical keys are at least in some cases superfluous and access to the vehicle can be effected quickly and easily using digital means. Finally, the vehicle management arrangement helps to reduce operating costs as it is less prone to loss or theft of physical keys and at the same time minimizes administrative effort. This combination of security, efficiency and ease of use makes the described vehicle management arrangement a powerful solution for modern vehicle management.

According to a preferred embodiment, the vehicle manufacturer backend device may be configured to cyclically rotate the encrypted immobilizer tokens and/or the unlock PINs.

Cyclic rotation means that the immobilizer tokens and/or unlock PINs are renewed according to a specified schedule. This process is controlled automatically by the vehicle manufacturer backend device and/or the vehicle manager backend device, with new immobilizer tokens and/or unlock PINs being generated and the old ones being cancelled. The frequency of rotation can vary depending on the specific security requirements and policies of the vehicle manufacturer or the car rental.

The method of operation of this embodiment offers several technical advantages. First, the regular renewal of security features improves the overall security of the vehicle management arrangement by limiting the life of each immobilizer token and/or unlock PIN. Even if an attacker comes into possession of an immobilizer token and/or an unlock PIN, it would be valid only for a short and defined period of time. This significantly minimizes the risk and potential impact of a security breach. Second, rotation protects against so-called replay attacks, where older intercepted data could be reused to gain unauthorized access. The invalidation of old immobilizer tokens and/or unlock PINs after a certain time renders such attacks ineffective.

Furthermore, the adaptability of the rotation frequency permits a flexible response to different security needs. In riskier environments or for higher-end vehicles, the frequency can be increased to adjust the level of security accordingly. Finally, the regular renewal of immobilizer tokens and/or unlock PINs helps to increase user confidence in the security of the vehicle management arrangement. Customers and business partners can be confident that proactive steps are being taken to protect their data and the vehicles.

According to another preferred embodiment, the control device of the vehicle is configured to apply a reset method after repeated incorrect entry of the unlock PIN, said method involving the waiting time for renewed entry of the unlock PIN being extended after each incorrect entry of an unlock PIN.

For example, this could be accomplished by implementing an exponential reset method involving the waiting time for renewed entry of an unlock PIN being exponentially extended after each incorrect entry of an unlock PIN. For example, the first incorrect entry of the unlock PIN would be followed by a waiting time of 30 seconds being imposed, the second incorrect entry would be followed by 60 seconds being imposed, and the third incorrect entry would be followed by entry being blocked for 120 seconds. Additionally, the control device of the vehicle could define a maximum number of permissible failed attempts after which the possibility of entering the unlock PIN is blocked completely and the vehicle can only be unlocked again by an authorized service employee or by a special release by the vehicle manager backend device. This measure significantly increases the security of the vehicle management arrangement, as it e.g. effectively stops brute force attacks and at the same time ensures that legitimate users are given another chance to enter the correct unlock PIN after a failed attempt.

According to another preferred embodiment, the control device of the vehicle may be configured to communicate wirelessly with the vehicle manufacturer backend device and/or the vehicle manager backend device.

The wireless communication technology implemented in the vehicles can take various forms, for example WiFi, Bluetooth, UWB, mobile radio networks or other forms of wireless data transmission. The choice of specific technology depends on multiple factors, including the range required, energy efficiency, cost and/or security of data transmission.

The method of operation of this embodiment allows seamless and efficient management of vehicle access. If, for example, a customer rents a vehicle or a service employee wants to use the vehicle, the vehicle manufacturer backend device or the vehicle manager backend device generates an immobilizer token and a related unlock PIN, which are then sent wirelessly to the vehicle. As soon as the vehicle receives the necessary data, the customer or the service employee can enter the unlock PIN using the human-machine interface in or on the vehicle and unlock and/or start the vehicle.

Wireless communication increases the flexibility and efficiency of vehicle access management. Customers and service employees benefit from a faster and smoother process because the need to hand over physical keys is eliminated. This reduces waiting times and improves customer or service employee satisfaction. Furthermore, wireless communication provides improved security over physical keys, as immobilizer tokens and/or unlock PINs can be protected using encryption techniques and easily changed or revoked when required.

According to another preferred embodiment, the human-machine interface can be a touchscreen.

In the embodiment described, the human-machine interface of a vehicle is in the form of a touchscreen. This human-machine interface allows interaction between the user and the vehicle system using touches on a screen, providing an intuitive and user-friendly method. The touchscreen serves as a central control element that allows users to enter the unlock PINs.

The method of operation of this embodiment is based on the implementation of touchscreen technology, which is already standard in many modern vehicles. The touchscreen responds to the user's touch and allows direct manipulation of the user interface. In this specific context, the touchscreen is used to enter the unlock PIN that is necessary to decrypt and deactivate the immobilizer token and thus allow access to the vehicle or enable it to be started. As soon as the user enters the unlock PIN using the touchscreen, the vehicle management arrangement processes the input and performs the appropriate action, for example unlocking the vehicle.

The touchscreen is typically incorporated in the dashboard or center console of the vehicle to allow convenient and intuitive interaction for the driver. Alternatively, the touchscreen may also be mounted on an exterior surface of the vehicle, for example next to the driver's door or near the door handle. This positioning allows users to enter the unlock PIN and deactivate the immobilizer token without having to enter the vehicle first. The touchscreen is configured e.g. as a robust, weatherproof and high-resolution display that responds to both touches and gestures from the user. The user interface is easy to use and provides clear, easy- to-understand menus and input fields for entering the unlock PIN. In addition, the touchscreen can display the current status of the immobilizer token, meaning that a user is always informed about the security status of the vehicle. As a result of the incorporation of modern touch technology, the screen ensures fast and precise entry, which is essential for efficient and secure use of the vehicle.

The human-machine interface could alternatively or additionally use voice control, gesture control and/or physical keys and/or rotary controls.

According to another preferred embodiment, the vehicle manufacturer backend device may be configured to provide the unlock PIN only for a predetermined period of time.

This approach is geared to increasing the security of access management by limiting the time for which the unlock PIN is valid. The unlock PIN is a critical security code that is used to decrypt and deactivate the immobilizer token and thus render the vehicle accessible to a user. As a result of the vehicle manufacturer backend device providing the unlock PIN only for a specified period of time, after which the unlock PIN becomes invalid, it is ensured that the unlock PIN cannot be permanently compromised.

The method of operation of this embodiment begins with the request for an unlock PIN by a user when access to a vehicle is needed. The vehicle manufacturer backend device then generates a time-limited unlock PIN, which is transferred to the user. This transfer can be made using various secure communication channels, for example using an encrypted mobile application or a special unit in the vehicle. As soon as the unlock PIN is used by the user, e.g. a timer can start, expiry of which is followed by the unlock PIN being automatically deactivated, regardless of whether or not it has been used. In addition, a means of protection could be implemented that, in the event of an unlock PIN being entered incorrectly, delays or even completely stops re-entry of the unlock PIN.

Limiting the time for the unlock PIN provides an additional layer of security because old or potentially intercepted unlock PINs can no longer be used after their validity has expired. This minimizes the risk of lost or stolen information resulting in unauthorized access to the vehicle. Moreover, this embodiment increases control over the use of vehicles, since access authorizations can be closely monitored and controlled, which is advantageous particularly e.g. in the car rental sector. Third, restricting the validity period of the unlock PIN can also make monitoring and managing vehicle use more efficient, since each use of the unlock PIN is associated with exactly one specific time window.

In addition, this embodiment helps to improve the user experience, as users are motivated to perform their transactions promptly and responsibly by the knowledge of the limited validity period of the unlock PIN. From an operational point of view, too, the time limit allows more efficient resource planning and resource use, as the access data must be regularly renewed, which requires continuous interaction with the system and thus also constantly updates security practices.

According to another preferred embodiment, the vehicle manager backend device may be configured to implement additional security measures such as two-factor authentication for accessing the unlock PINs.

Two-factor authentication uses two different and independent components to verify a user's identity, greatly increasing security.

The method of operation of this embodiment begins when a user or system requests access to a vehicle and in so doing needs to enter an unlock PIN. In addition to entering the unlock PIN, two-factor authentication requires a user to provide a second form of identification. This could take the form of a physical token or biometric verification such as a fingerprint and/or a face scan, or involve the use of a secure mobile device that generates a unique authentication identifier. Access to the unlock PIN is possible only once both factors have been successfully verified.

Two-factor authentication increases security by making it much more difficult to gain unauthorized access. Even if an attacker were to decrypt or guess the unlock PIN, they would be denied access if they were not also able to produce the second authentication factor. This significantly reduces the risk of theft or unauthorized use of the vehicle.

In addition, two-factor authentication increases user confidence in the security of the vehicle management arrangement. Customers and operators can be sure that vehicles are used only by authorized persons, which can be crucial especially in the car rental sector, where vehicles are often used by different users.

In addition, implementing two-factor authentication can meet or even exceed regulatory requirements, helping car rental companies to meet compliance requirements and minimize potential legal risks. It also reduces fraud by providing a more robust method for checking identity, ultimately lowering the operating costs that fraud and theft could cause.

In summary, this embodiment provides a significant increase in security and reliability in vehicle access management through the incorporation of two-factor authentication, resulting in improved overall security, increased user confidence and more efficient compliance with security standards.

According to another preferred embodiment, the vehicle may be configured to remain enabled for a predetermined number of engine starts after entry of the unlock PIN.

The method of operation of this embodiment is based on the control device incorporating a counter for engine starts that is activated as soon as the correct unlock PIN has been entered. The unlock PIN itself is a security code that is configured to decrypt the immobilizer token to unlock the vehicle and/or be able to start the engine. After entry of this unlock PIN and successful verification by the control device, the engine start counter is activated. The remaining number of possible engine starts should be displayed using the human-machine interface (HMI). This counter limits the number of engine starts that are possible without re-entering the unlock PIN. Once the specified number of starts has been reached, the vehicle is automatically disabled again and a new unlock PIN must be re-entered to be able to continue using the vehicle.

Limiting the number of engine starts after each PIN entry ensures that a potential thief can start the vehicle only a limited number of times, even if they have gained access to the correct unlock PIN. This can be particularly useful if a vehicle is stolen unnoticed, as it prevents the thief from using the vehicle for a prolonged period of time without re-authorization.

In addition, this function increases ease of use for legitimate users who want to use the vehicle for short, repeated journeys without having to re-enter the unlock PIN each time. This is particularly advantageous in scenarios such as car rentals or car-sharing services, where vehicles are often used for short periods of time.

Moreover, this embodiment allows more accurate control and management of vehicle use. Vehicle managers can implement specific policies directed at how often a vehicle can be started before re-authentication is required, which can be useful for monitoring and regulating patterns of use.

In summary, this embodiment provides a reasonable balance between ease of use and security by allowing temporary but limited access to the vehicle and at the same time ensuring that the vehicle cannot be operated beyond the specified use without further authentication.

However, it is critical to safety to consider what happens when the maximum number of engine starts has been reached and another engine start would be required, for example in a hazardous area. In such cases, an additional safety mechanism could be implemented that allows an emergency start to ensure the safety of the user. One possible approach to implementing an emergency start could be to use an emergency PIN that is issued in addition to the normal unlock PIN. This emergency PIN could be activated only in specific situations, for example when the maximum number of engine starts has been reached and the vehicle is in a hazardous area. After entry of the emergency PIN, the vehicle is enabled, e.g. only for a short, defined period of time within which it can be started and used. This time limit ensures that the vehicle can be used only in the event of extreme emergency, and prevents prolonged, potentially unauthorized, use. After this short period of time has elapsed, the vehicle is automatically disabled again, and so another start is possible only after re-entry of a valid unlock PIN.

According to another preferred embodiment, the control device of the vehicle may be configured to send the status of the immobilizer, in particular the status of the immobilizer token and of the unlock PIN, to the vehicle manager backend device. In this case, the control device could e.g. additionally transfer other meta-information, for example the number of incorrect entries of the unlock PIN, the number of remaining entry attempts for entering the unlock PIN, the number of remaining engine starts and the length of time for which the immobilizer was unlocked, i.e. the length of time for which the vehicle was in the "DRIVING" state. This expanded information would allow more precise monitoring and management of vehicles.

This functionality allows continuous and effective monitoring of the security states of the vehicle by the vehicle manager, which is an essential aspect of vehicle fleet management and security.

The immobilizer tokens are configured to disable or enable the vehicle, depending on the correct entry of an appropriate unlock PIN by a user. The control device in the vehicle is responsible for determining the current states of these elements. This includes whether an immobilizer token is active - i.e. the immobilizer token has not been decrypted and the vehicle is disabled by the immobilizer - or has been deactivated - the immobilizer token has been decrypted and the vehicle is enabled by the immobilizer - and the status of the unlock PIN as to whether or not it has been successfully verified.

The method of operation of this embodiment begins with the detection of an event, such as entry of an unlock PIN or activation or deactivation of the immobilizer as a result of decryption of the immobilizer token. The control device acquires this information and transfers it to the vehicle manager backend device using a secure connection. This data transmission occurs in real time or at predefined intervals, depending on the configuration of the vehicle management arrangement.

The technical advantages of this embodiment are manifold. First, transferring the status of the immobilizer and/or other meta-information allows better control and monitoring of the vehicle. In this way, vehicle managers can quickly respond to security incidents, such as an attempt to use a vehicle without authorization, and take appropriate measures, for example disabling the vehicle again remotely.

Second, this function improves the overall security architecture of rental car management, as it provides continuous feedback about the state of each vehicle. This allows managers to obtain more accurate data on the patterns of use and security of their vehicles, which in turn can help to optimize operating procedures and prevent theft or misuse.

In addition, the ability to monitor and communicate the status of security elements such as immobilizer tokens and unlock PINs and other meta-information helps to comply with insurance and regulatory requirements. This can lower insurance costs and ensure compliance with legal requirements by demonstrating that effective security and monitoring mechanisms are in place.

Overall, by incorporating advanced communication technologies, this embodiment provides a robust solution for vehicle management that not only increases security and efficiency but also strengthens the confidence of customers and business partners in the rental company.

According to another preferred embodiment, the human-machine interface may be configured to display the current status of the immobilizer token.

The human-machine interface serves as an information portal for the user that allows them to view the operating state of the vehicle and specific security functions and/or meta-information.

The status of this immobilizer token can indicate whether the vehicle is currently disabled or enabled. The ability of the human-machine interface to present this status clearly and distinctly provides direct communication between the vehicle security system and the user.

The method of operation of this embodiment typically involves real-time data processing and display. For example, when the user enters the unlock PIN, the control device processes that input, checks it and updates the status of the immobilizer token and/or of the immobilizer accordingly. The updated status is then immediately displayed on the human-machine interface, providing the user with direct feedback about the success or failure of their input.

The technical advantages of this embodiment are considerable. First, the clear and immediate display of the immobilizer token status and/or of the immobilizer and/or of the meta-information improves the ease of use and accessibility of the vehicle. Users can see at a glance whether further actions are required on their part to start or secure the vehicle, which is advantageous especially in stressful or urgent situations.

Second, this function increases the security of the vehicle use process. As users are always informed about the status of the vehicle, they can ensure that the vehicle does not unintentionally remain unsecured. This helps to minimize the risk of theft or unauthorized use of the vehicle.

In addition, the implementation of such an interface encourages user confidence in the vehicle and its security systems. The transparency that the system provides makes users feel safer and more comfortable with the technology, contributing to customer satisfaction and loyalty.

According to another preferred embodiment, the vehicle manufacturer backend device may be configured to transmit the encrypted immobilizer tokens and unlock PINs using a secure connection.

The method of operation of this embodiment comprises multiple key components. First, the vehicle manufacturer backend device generates the encrypted immobilizer token and the unlock PIN that is intended for a specific vehicle or a specific user. These data are then sent using a secure connection that is based on robust encryption methods such as SSL/TLS (Secure Sockets Layer / Transport Layer Security) or VPN (Virtual Private Network) or mTLS (mutual TLS). These technologies ensure that the data cannot be read or altered by third parties during transmission.

The secure transmission of the immobilizer tokens and unlock PINs dramatically reduces the risk of data leakage or cyberattacks. This not only protects the privacy and security of users but also strengthens confidence in the vehicle management arrangement. Additionally, this embodiment helps to ensure compliance with legal data protection regulations, which is critically important for manufacturers in an increasingly regulated environment.

Furthermore, the use of secure connections improves the reliability of the vehicle management arrangement. Data transferred correctly and without being tampered with ensure that the vehicle access systems operate as intended and that no malfunctions occur due to data corruption. This increases overall system stability and reduces the need for technical support and maintenance.

Overall, by securely transmitting critical security data, this embodiment allows a robust, reliable and trusted environment for vehicle management, improving both security and the user experience.

According to another preferred embodiment, the control device of the vehicle may be configured to receive and implement wireless instructions for remotely locking and unlocking the vehicle using the vehicle manufacturer backend device and/or a vehicle manager backend device.

The control device in the vehicle is typically equipped with modern telematics technology that makes it possible to send and receive signals securely using mobile radio networks or other wireless communication methods. The control device receives specific, encrypted commands from the vehicle manufacturer backend device or the vehicle manager backend device. These commands are then interpreted and implemented by the control device of the vehicle in order to initiate appropriate actions such as locking or unlocking the doors or activating or deactivating the immobilizer.

The method of operation of this embodiment comprises multiple steps. First, a secure connection between the control device of the vehicle and the vehicle manufacturer backend device and/or the vehicle manager backend device is established that can be used to transmit commands. This connection preferably uses robust encryption protocols to ensure the security of the transmitted data. As soon as a remote locking or unlocking command is received, it is processed by the control device and forwarded to the control device that activates the physical mechanisms for locking or unlocking or activating or deactivating the immobilizer.

One of the main advantages is increased flexibility and convenience for the user and also for the operators of the vehicle manager. For example, users can unlock their vehicle before they physically arrive at the vehicle, or can ensure that the vehicle is locked after they have left it, even if they originally forgot to do so. For operators, this functionality provides the ability to respond to emergencies, for example to disable the vehicle remotely if it has been stolen.

Another advantage is improved security. The ability to lock and unlock vehicles remotely or activate or deactivate the immobilizer can help to prevent or minimize theft by allowing rapid action. Moreover, this technology can help to make the use of vehicles more efficient, for example by dynamically managing access rights for vehicles based on actual use or the booking situation.

Overall, by implementing advanced wireless communication technologies, this embodiment provides significant expansion of the operational and security capabilities of vehicles, which can improve both customer satisfaction and operational efficiency.

According to another preferred embodiment, the vehicle manager backend device may be configured to provide the unlock PIN at the request of a user after the vehicle has been returned without an open booking, in order to allow engine starts for maintenance purposes.

As soon as a vehicle is returned and marked in the system as "No open booking", a service employee or other authorized user can contact the car rental company backend device to obtain a temporary unlock PIN.

The method of operation of this embodiment begins with the return of a vehicle, which is then recorded in the car rental company's management system as available without a booking. Service employees or other authorized persons can then make a request to the vehicle manager backend device to gain access to the vehicle. The vehicle manager backend device then generates an unlock PIN valid specifically for the requested purpose and transfers it securely to the appropriate person. The unlock PIN then allows e.g. the engine to be started, which may be necessary for inspections, repairs or other maintenance work.

This embodiment allows improved maintenance efficiency, as vehicles can be quickly and easily rendered accessible for necessary checks and maintenance. This is particularly important in a commercial environment, where vehicle downtime needs to be minimized and availability needs to be maximized. Moreover, this functionality increases security, as the unlock PIN is issued only on request and only for specific, documented purposes. This helps to prevent unauthorized access and ensures that only authorized persons have access to the vehicles.

In addition, this approach can improve operational flexibility by allowing the car rental company to respond quickly to unforeseen maintenance needs. Since service employees can start vehicles when required, potential problems can be identified and resolved more quickly, increasing the overall reliability of the vehicles. This embodiment thus not only assists direct vehicle maintenance but also contributes to long-term vehicle maintenance and optimization, which can ultimately promote customer satisfaction and the commercial success of the car rental company.

According to another preferred embodiment, the vehicle manager backend device may also be configured to log and limit the number of engine starts that can be performed after the unlock PIN has been provided.

This embodiment aims to precisely monitor and control use of the vehicle, especially after a user or service employee has gained access to the vehicle.

The method of operation of this embodiment begins with the vehicle manager backend device generating and providing an unlock PIN that allows a user or service employee to access the vehicle. As soon as the unlock PIN is used, the vehicle management arrangement activates a function that counts each engine start. The vehicle manager backend device can e.g. stipulate how often the engine can be started before access is disabled again. The number of engine starts remaining could be displayed e.g. using the human-machine interface (HMI). This is often used in scenarios where a vehicle has been enabled for maintenance work and it must be ensured that the vehicle is not used beyond the intended use.

The vehicle manager backend device stores and manages these data centrally so that they can be retrieved for later checks or for analyzing vehicle use. By logging starting procedures, the vehicle manager can keep detailed records of the use of each vehicle. This information is particularly valuable for vehicle fleet management as it helps to identify and prevent unauthorized or unexpected use.

One advantage is increased security and control over the vehicle fleet. By limiting the number of engine starts, vehicle managers can ensure that vehicles are not used beyond the permitted extent. This is particularly important in cases where vehicles are temporarily enabled for service or maintenance purposes, as it significantly reduces the possibility of misuse.

In addition, this functionality allows better management and maintenance of the vehicles. Accurately monitoring how often a vehicle has been started allows maintenance intervals to be better planned and overall vehicle maintenance to be optimized. This results in longer vehicle life and potentially lower maintenance costs.

Another advantage is improved operational efficiency. By understanding vehicle use in detail, vehicle managers can make informed decisions about how to use their vehicles, which contributes to optimized resource use and more efficient vehicle management.

Overall, this embodiment provides expanded control and monitoring of vehicle use, which not only improves security and maintenance but also helps to lower operating costs and increase end-user satisfaction.

According to another preferred embodiment, the vehicle may be configured to automatically send an acknowledgement to the vehicle manager backend device as soon as the unlock PIN has been used to confirm the complete and safe return of the vehicle.

The vehicle is equipped with a control device capable of transferring data directly to the vehicle manager backend device. As soon as the unlock PIN is entered by a service employee at the end of a rental period in order to unlock and prepare the vehicle for return, the vehicle's system detects this process and initiates the transfer of an acknowledgement. This acknowledgment contains specific data confirming that the vehicle has been duly returned.

The vehicle manager backend device receives these data and updates the status of the vehicle in its system, triggering administrative and security processes.

The automatic acknowledgement allows the vehicle manager to ensure that the vehicle has actually been returned and is in a secure state. This minimizes the risk of theft or loss after return. Additionally, this functionality allows faster and more accurate processing of returns, as the information about the return can be updated directly in the vehicle manager's system without manual input or delays.

Another advantage is improved customer service. Customers can receive confirmation that their rental contract has been duly completed immediately upon return, which increases confidence in the rental process and avoids potential conflicts or ambiguities regarding return of the vehicle.

In summary, by automating the acknowledgement process, this embodiment provides an efficient, secure and user-friendly solution that offers significant advantages for both the car rental company and the customer. This helps to streamline administrative processes and at the same time increase security and satisfaction.

According to another preferred embodiment, the vehicle manager backend device may be configured to automatically send an encrypted immobilizer token to the vehicle after termination of a rental agreement pertaining to the vehicle in order to secure the vehicle until the next rental.

The process begins when a specific vehicle has been duly returned and the vehicle manager has identified the vehicle as "returned" or "ready". The vehicle manager backend device is informed of the end of the rental agreement, either by manual entry by the personnel or automatically by a vehicle management system. The vehicle manager backend device then generates a new encrypted immobilizer token intended specifically for the vehicle in question. This immobilizer token is then sent to the vehicle, modern encryption methods being able to be used to ensure the security of data transmission.

As soon as the vehicle receives the new immobilizer token, said token is activated and the vehicle is automatically disabled by the immobilizer. This prevents the vehicle from being able to be started or used without the appropriate authorization. The immobilizer token remains active until it is decrypted and deactivated by an authorized person who knows a corresponding unlock PIN, or until a new rental agreement is started, for which another immobilizer token is generated and sent.

Automatically disabling the vehicles immediately after the vehicle has been taken back by the vehicle manager significantly reduces the risk of unauthorized access. This is particularly important in car rentals, where vehicles often change location and are used by different persons. Encryption of the immobilizer token also ensures that it cannot be tampered with or circumvented by unauthorized parties. Additionally, a safety mechanism could be implemented that allows an emergency start in order to ensure the safety of the user. One possible approach to implementing an emergency start could be to use an emergency PIN that is issued in addition to the normal unlock PIN. This emergency PIN could be activated only in specific situations, for example when the maximum number of engine starts has been reached and the vehicle is in a hazardous area.

Automating the process of sending and activating immobilizer tokens reduces administrative effort and the need for manual intervention, which can lead to faster procedures and lower operating costs. The vehicle manager backend device also allows central monitoring and control of vehicle security, simplifying management of the entire vehicle fleet.

Overall, this embodiment contributes to improving the security and management efficiency of vehicle fleets by providing a reliable, automated solution for securing vehicles between rentals. This not only increases customer confidence in the security of the rental but also assists risk management and the operational performance of the car rental company.

Further features, advantages and effects of the present disclosure can be found in the following description of preferred embodiments of the present disclosure.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic block diagram of an embodiment of a vehicle management arrangement according to the present disclosure;

FIG. 2 shows a schematic flow diagram of an embodiment of a vehicle management method according to the present disclosure; and

FIG. 3 shows a schematic flow diagram of another embodiment of a vehicle management method according to the present disclosure.

FIG. 4 shows a schematic UML diagram of a section of another embodiment of a vehicle management method according to the present disclosure.

FIG. 5 shows a schematic UML diagram of a section of another embodiment of a vehicle management method according to the present disclosure.

FIG. 6 shows a schematic UML diagram of a section of another embodiment of a vehicle management method according to the present disclosure.

FIG. 7 shows a schematic UML diagram of a section of another embodiment of a vehicle management method according to the present disclosure.

### DETAILED DESCRIPTION OF THE DRAWINGS

Corresponding or identical parts are each provided with the same reference signs in the figures.

If appropriate, the configurations and developments described can be combined with each other as desired. Further possible configurations, developments and implementations of the present disclosure also include not explicitly mentioned combinations of features of the present disclosure that are described above or hereinafter with regard to the embodiments.

The accompanying drawings are intended to provide additional understanding of the embodiments of the present disclosure. They illustrate embodiments and are used in combination with the description to explain principles and concepts of the present disclosure. Other embodiments and many of the advantages mentioned will be apparent from the drawings. The elements of the drawings are not necessarily shown to scale in relation to each other. Identical reference signs denote components that are identical or have a similar effect.

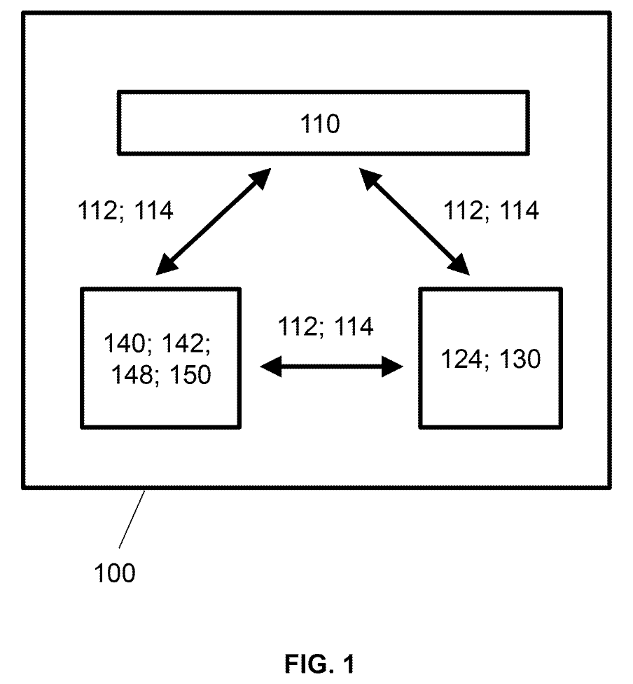

FIG. 1 shows a schematic block diagram of an embodiment of a vehicle management arrangement 100 according to the present disclosure. The vehicle management arrangement 100 comprises a vehicle manufacturer backend device 110 configured for generating, managing and distributing encrypted immobilizer tokens 112 and unlock PINs 114. Each immobilizer token 112 is configured to release an immobilizer 150 of a vehicle 140 when the corresponding unlock PIN 114 is entered. The vehicle manager backend device 124 communicates with the vehicle manufacturer backend device 110 to receive the encrypted immobilizer tokens 112 and unlock PINs 114 and forward them to a vehicle manager terminal 130. The vehicle 140 is equipped with a control device 142 that receives the encrypted immobilizer tokens 112 from the vehicle manufacturer backend device 110 and/or the vehicle manager backend device 124 and decrypts them after entry of the unlock PIN 114 in order to release the immobilizer 150.

Optionally, the control device 142 of the vehicle 140 may be configured such that the decrypted immobilizer token 112 and the unlock PIN 114 are immediately discarded after release of the immobilizer 150 in order to prevent reuse of the unlock PIN 114. The vehicle manufacturer backend device 110 may furthermore be configured such that it cyclically rotates the encrypted immobilizer tokens 112 and/or the unlock PINs 114.

The control device 142 of the vehicle 140 can moreover communicate wirelessly with the vehicle manufacturer backend device 110 and/or the vehicle manager backend device 124. The vehicle 140 may be configured such that it remains enabled for a predetermined number of engine starts after entry of the unlock PIN 114. The control device 142 of the vehicle 140 can furthermore send the status of the immobilizer 150, in particular the status of the immobilizer token 112 and of the unlock PIN 114, to the vehicle manager backend device 124.

The human-machine interface 148 of the vehicle 140 can display the current status of the immobilizer token 112 or of the immobilizer 150 or other meta-information. In addition, the control device 142 of the vehicle 140 can receive wireless instructions for remotely locking and unlocking the vehicle 140 and can implement them using the vehicle manufacturer backend device 110 and/or the vehicle manager backend device 124. After termination of a rental agreement, the vehicle manager backend device 124 can automatically send an encrypted immobilizer token 112 to the vehicle 140 in order to secure the vehicle 140 until the next rental.

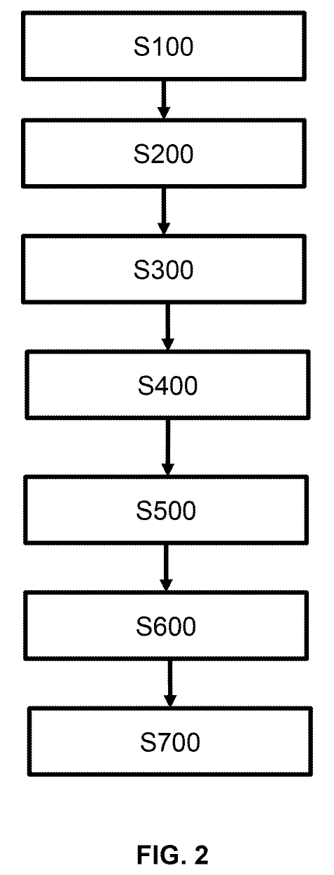

FIG. 2 shows a schematic flow diagram of an embodiment of a vehicle management method according to the present disclosure. The vehicle management method comprises steps S100; S200; S300, S400, S500; S600 and S700.

In step S100, encrypted immobilizer tokens 112 and unlock PINs 114 are generated by a vehicle manufacturer backend device 110, each immobilizer token 112 being configured to release an immobilizer 150 of the vehicle 140 when the corresponding unlock PIN 114 is entered.

In step S200, the encrypted immobilizer tokens 112 and unlock PINs 114 are managed by the vehicle manufacturer backend device 110 and distributed to a vehicle manager backend device 124.

Step S300 comprises forwarding the encrypted immobilizer tokens 112 and unlock PINs 114 from the vehicle manager backend device 124 to a vehicle manager terminal 130.

In step S400, a control device 142 of the vehicle 140 receives the encrypted immobilizer tokens 112 from the vehicle manufacturer backend device 110 and/or the vehicle manager backend device 124.

Step S500 involves entry of the unlock PIN 114 by a user of the vehicle 140.

In step S600, the immobilizer token 112 is decrypted by the control device 142 after entry of the corresponding unlock PIN 114.

Finally, in step S700, the immobilizer 150 of the vehicle 140 is released by the control device 142 after successful decryption of the immobilizer token 112.

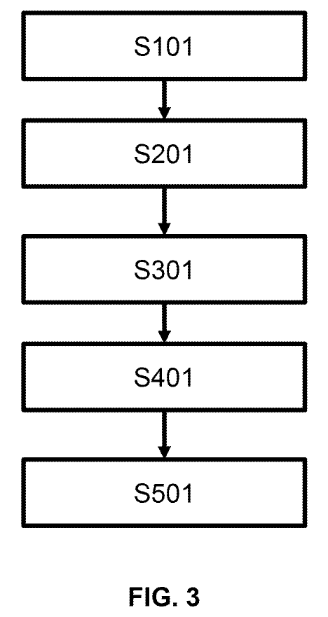

FIG. 3 shows a schematic flow diagram of another embodiment of a vehicle management method according to the present disclosure. The vehicle management method according to this embodiment comprises five method steps S101, S201, S301, S401 and S501. In step S101, the vehicle manufacturer backend device 110 configures specific security settings for a vehicle 140. This involves generating and encrypting immobilizer tokens 112 and generating related unlock PINs 114 that make the vehicle 140 accessible only to authorized users.

In step S201, the vehicle manufacturer backend device 110 securely transfers the encrypted immobilizer tokens 112 and unlock PINs 114 to the vehicle manager backend device 124, which is responsible for distributing this security data to the appropriate vehicle 140.

When the data are received in the vehicle 140, the control device 142 activates the received immobilizer token 112 in step S301. This step ensures that the vehicle 140 cannot be started without entry of the correct unlock PIN 114.

In step S401, the authorized user enters the unlock PIN 114 using a human-machine interface 148 in order to unlock the vehicle 140 and enable it for use. After correct entry, the immobilizer token 112 is deactivated so that the user can start and use the vehicle 140.

After use of the vehicle 140, the control device 142 collects relevant use data, for example the number of engine starts performed, in step S501 and sends these data back to the vehicle manager backend device 124. This information can be used to analyze and optimize vehicle use.

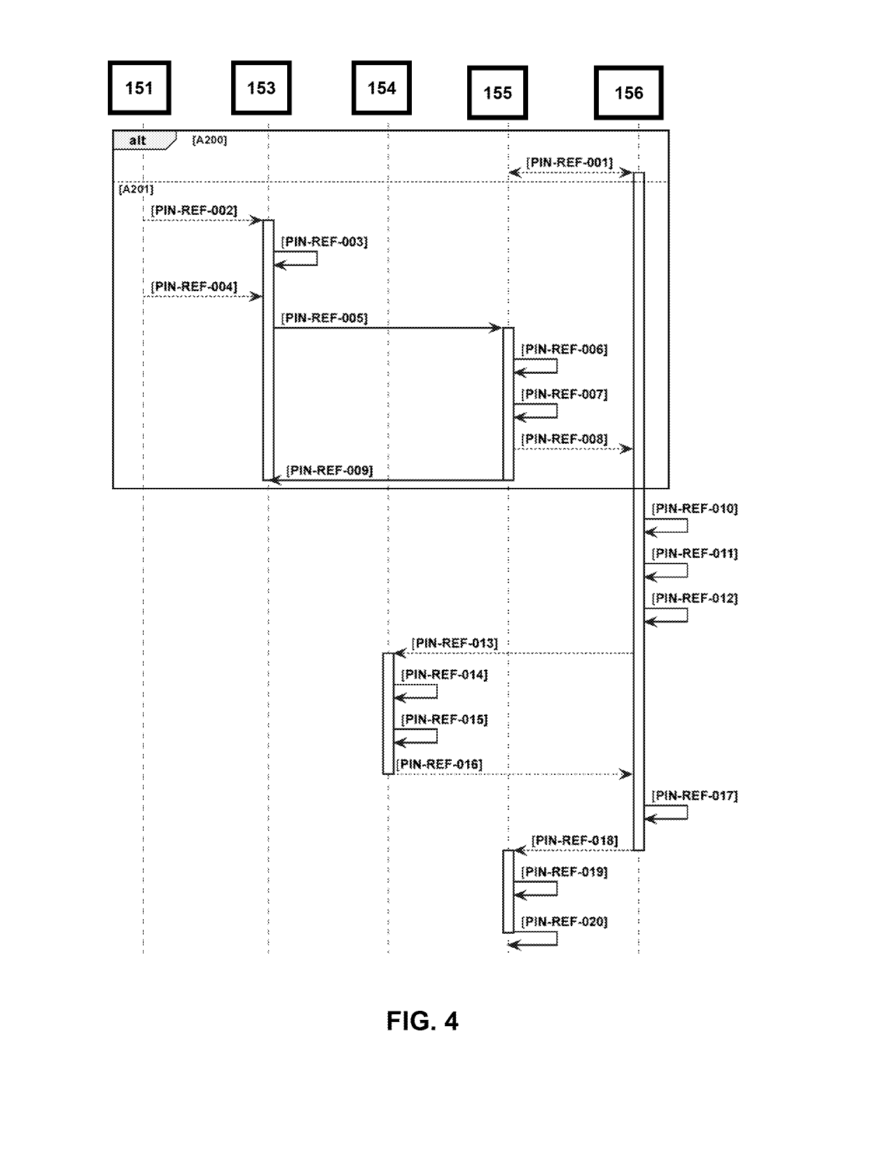

FIG. 4 shows a schematic UML diagram of a section of another embodiment of a vehicle management method according to the present disclosure. In particular, FIG. 4 shows the sequence of a method for renewing an unlock PIN 114. The vehicle management method begins when a customer 150 returns the vehicle 140. A service employee 151 receives the vehicle 140 from the customer 150 and performs the necessary tasks with the vehicle 140, these tasks also being able to be performed by multiple persons. A vehicle manager backend device 153, e.g. a special app for managing vehicles 140, assists the service employee 151 in performing these tasks.

First, a vehicle management introduction method (PIN-REF-001) is carried out between the vehicle manager backend device 155 and the vehicle manufacturer backend device 156. A barcode of the vehicle 140 is then scanned to display the details of the vehicle 140 (PIN-REF-002 and PIN-REF-003). Processing of the vehicle 140 is then completed (PIN-REF-004), followed by the request to complete processing of the vehicle 140 for the vehicle identification number (VIN) (PIN-REF-005). Next, the status of the vehicle 140 is updated to "Ready for booking" (PIN-REF-006) and it is specified that an update of the unlock PIN 114 is pending (PIN-REF-007). An event notification to update the unlock PIN 114 is sent (PIN-REF-008).

During the return process, the vehicle 140 is returned to the vehicle manager backend device 153 (PIN-REF-009). A check ensures that the vehicle 140 is in rental mode (PIN-REF-010). A new immobilizer token 112 and a new unlock PIN 114 are generated (PIN-REF-011), stored (PIN-REF-012), and sent to vehicle 140 (PIN-REF-013). A recheck ensures that the vehicle 140 is still in rental mode (PIN-REF-014), and the stored immobilizer token 112 is used for the new unlock PIN 114 (PIN-REF-015). Once update is successful, a confirmation is sent (PIN-REF-016), the status of the update of the immobilizer token 112 is specified (PIN-REF-017), and a notification about the new unlock PIN 114 for the specific VIN is sent (PIN-REF-018). The unlock PIN 114 is stored in the vehicle management arrangement 100 for the corresponding VIN (PIN-REF-019), and the status is set to "unlock PIN 114 updated" (PIN-REF-020).

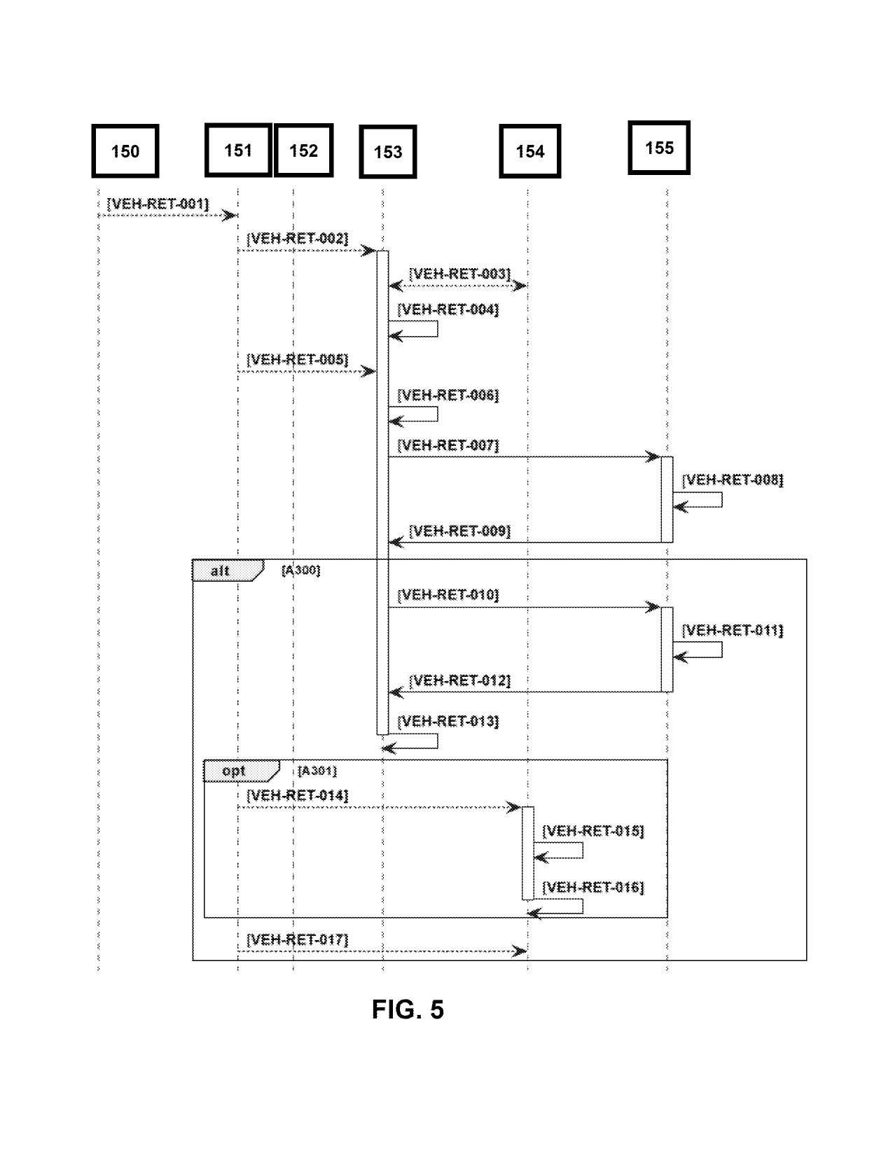

FIG. 5 shows a schematic UML diagram of a section of another embodiment of a vehicle management method according to the present disclosure. In particular, FIG. 5 shows a method for returning a vehicle 140. After the vehicle 140 has been fully processed and a rental agreement has been terminated (VEH-RET-001), the QR code / barcode of the vehicle 140 is re-scanned (VEH-RET-002) and due return of the vehicle 140 is confirmed (VEH-RET-005). The status of the vehicle 140 is set to "Returned" (VEH-RET-006) and the corresponding update is requested (VEH-RET-007). Upon completion of this process, a new unlock PIN 114 can be requested (VEH-RET-010), the vehicle management arrangement 100 ensuring that the vehicle 140 has actually been marked as returned (VEH-RET-011). The unlock PIN 114 is finally entered using the human-machine interface 148 (VEH-RET-014), verified (VEH-RET-015), and an engine start can be carried out (VEH-RET-016). The unlock PIN 114 is then written onto the windshield or a note (VEH-RET-017).

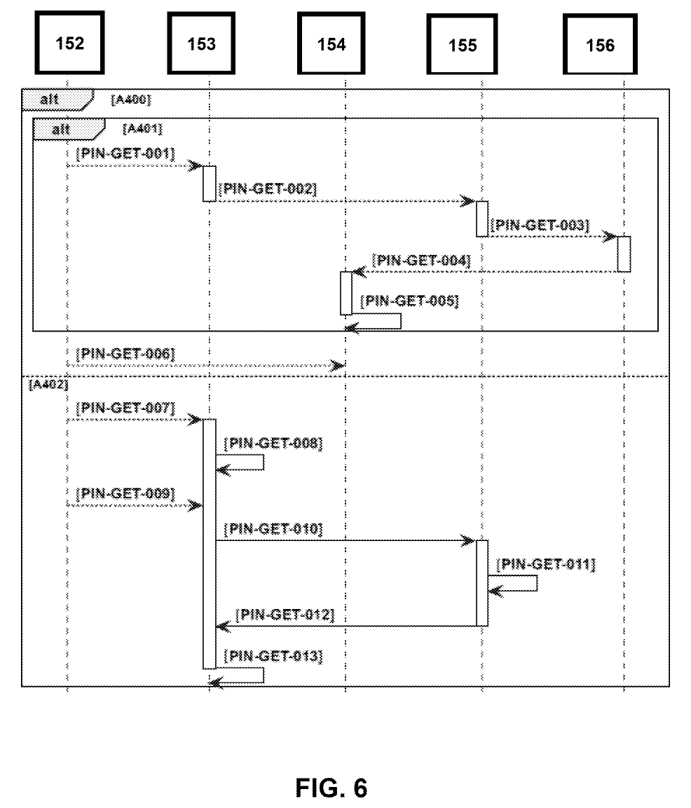

Additionally, the method comprises steps to securely unlock and use the vehicle 140. The method shown in FIG. 6 begins with the unlocking of the vehicle 140 (PIN-GET-001 and PIN-GET-002), either directly or by requesting remote unlocking using remote services (PIN-GET-003). After the vehicle 140 has been unlocked (PIN-GET-004), the doors are unlocked (PIN-GET-005) to allow access to the vehicle interior of the vehicle 140. The windshield or a possible note is then checked (PIN-GET-006) in order to determine relevant information. The barcode of the vehicle 140 is scanned (PIN-GET-007) in order to display specific details of the vehicle 140 (PIN-GET-008).

The next step in the method is to request the unlock PIN 114 (PIN-GET-009) based on the specific vehicle identification number (VIN) (PIN-GET-010). It is checked whether the status of the vehicle is "Returned" (PIN-GET-011) in order to ensure that the vehicle 140 is ready for use. Once the unlock PIN 114 has been obtained (PIN-GET-012), it is displayed on the human-machine interface 148 (PIN-GET-013) to allow the vehicle 140 to be started.

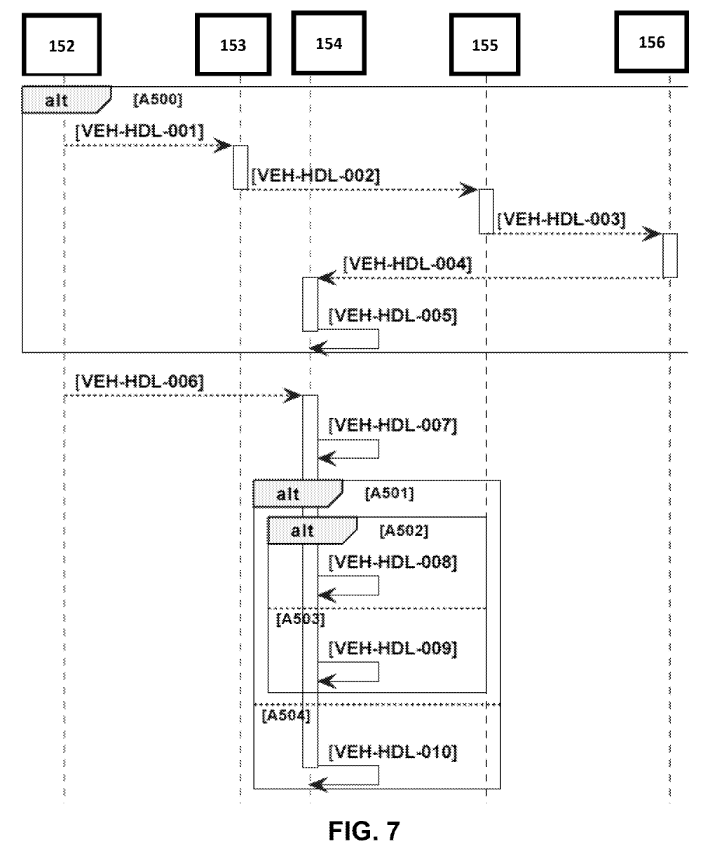

FIG. 7 shows a schematic UML diagram of a section of another embodiment of a vehicle management method according to the present disclosure. In particular, FIG. 7 shows a method for managing the return of a vehicle 140. As part of the processing of the vehicle 140, the vehicle 140 can be unlocked (VEH-HDL-001 and VEH-HDL-002), which can also be requested using remote services (VEH-HDL-003). After the vehicle 140 (VEH-HDL-004) and the doors (VEH-HDL-005) have been unlocked, the user enters the unlock PIN 114 using the human-machine interface 148 (VEH-HDL-006) in order to decrypt the immobilizer token 112 with the unlock PIN 114 (VEH-HDL-007).

If the unlock PIN 114 entered is incorrect, there are a limited number of attempts before entry of the unlock PIN 114 is blocked (VEH-HDL-008). Each incorrect entry of the unlock PIN 114 results in the blocking time for re-entry of the unlock PIN being increased (VEH-HDL-009), e.g. exponentially, in order to maximize security. If the unlock PIN 114 is entered correctly, the immobilizer token 112 is decrypted and the engine of the vehicle 140 can be started (VEH-HDL-010), so that the vehicle 140 can be used.

These comprehensive security measures and method steps ensure that the vehicle 140 is used only by authorized persons, while at the same time ensuring smooth and efficient management for use of the vehicle 140.

The foregoing disclosure has been set forth merely to illustrate the present disclosure and is not intended to be limiting. Since modifications of the disclosed embodiments incorporating the spirit and substance of the present disclosure may occur to persons skilled in the art, the present disclosure should be construed to include everything within the scope of the appended claims and equivalents thereof.

### List of reference signs

100 Vehicle management arrangement

110 Vehicle manufacturer backend device

112 Immobilizer token

114 Unlock PIN

124 Vehicle manager backend device

130 Vehicle manager terminal

140 Vehicle

142 Control device in the vehicle

148 Human-machine interface

150 Customer

151 Vehicle handler (Intro) - receive the vehicle from the customer

152 Vehicle handler (Doing) - perform tasks with the vehicle (could also be carried out by 10 or more different persons)

153 Intro handler app – vehicle manager backend device (app for managing vehicles)

154 Vehicle

155 Rental backend – vehicle manager backend device

156 Vehicle OEM backend – vehicle manufacturer backend device

PIN-REF-001 Vehicle infleeting process – vehicle management introduction method

PIN-REF-002 Scan vehicle barcode - scan the vehicle's barcode

PIN-REF-003 Show vehicle details – display the vehicle's details

PIN-REF-004 Perform 'Vehicle Handling Complete' – perform 'completion of vehicle processing'

PIN-REF-005 Request: Vehicle Handling Complete for VIN - request: completion of vehicle processing for the vehicle identification number (VIN)

PIN-REF-006 Update vehicle status: 'READY FOR BOOKING' – update the vehicle's status: "Ready to book"

PIN-REF-007 Set status: 'PIN UPDATE PENDING' - specify status: "update of the unlock PIN pending"

PIN-REF-008 Event notification: Refresh Engine Start PIN - event notification: update the unlock PIN

PIN-REF-009 Return - return

PIN-REF-010 Check: Vehicle in RENTAL Mode - check: the vehicle is in rental mode

PIN-REF-011 Generate Engine Start Immotoken+PIN – generate the immobilizer token and the unlock PIN

PIN-REF-012 Persist Immotoken+PIN – store the immobilizer token and the unlock PIN

PIN-REF-013 Push Immotoken - send the immobilizer token

PIN-REF-014 Check: Vehicle in RENTAL Mode - check: the vehicle is in rental mode

PIN-REF-015 Persist Immotoken for PIN - store the immobilizer token for the unlock PIN

PIN-REF-016 Push Confirmation - send confirmation

PIN-REF-017 Set: Immotoken Update Confirmed - specify status: "update immobilizer token confirmed"

PIN-REF-018 Event Notification: Vehicle PIN for VIN - event notification: unlock PIN for the VIN

PIN-REF-019 Persist PIN for VIN – store the unlock PIN for the VIN

PIN-REF-020 Set status: 'PIN UPDATED' - specify status: "unlock PIN updated"

VEH-RET-001 Turn over vehicle - Terminate booking in rental app - hand over vehicle - terminate the vehicle's booking in the vehicle manager backend device (rental app)

VEH-RET-002 Scan Vehicle QR/Barcode - scan the vehicle's QR code / barcode

VEH-RET-003 Scan QR/Barcode - scan the QR code / barcode

VEH-RET-004 Open Vehicle Screen - open the vehicle screen

VEH-RET-005 Confirm Return – confirm return of the vehicle

VEH-RET-006 Set vehicle status 'RETURNED' – set the vehicle's status to "Returned"

VEH-RET-007 Request: Update vehicle status - request: update the vehicle's status

VEH-RET-008 Update vehicle status: 'RETURNED' – update the vehicle's status: "Returned"

VEH-RET-009 Return - return

VEH-RET-010 Request: Request Engine Start PIN - request: request the unlock PIN

VEH-RET-011 Check if vehicle status is 'RETURNED' - check whether the vehicle's status is "Returned"

VEH-RET-012 Return: Engine start PIN - return: unlock PIN

VEH-RET-013 Show Engine Start PIN - display the unlock PIN

VEH-RET-014 Enter PIN via HMI - enter the unlock PIN using the human-machine interface (HMI)

VEH-RET-015 Verify PIN - verify the unlock PIN

VEH-RET-016 Perform Engine Start - perform an engine start

VEH-RET-017 Write PIN to windscreen / paper note / ... - write the unlock PIN on the windshield / a note

PIN-GET-001 Unlock vehicle - unlock the vehicle

PIN-GET-002 Unlock vehicle - unlock the vehicle

PIN-GET-003 Request vehicle unlock (remote services) - request unlocking of the vehicle (remote services)

PIN-GET-004 Unlock vehicle - unlock the vehicle

PIN-GET-005 Unlock doors - unlock the doors

PIN-GET-006 Check windscreen / paper note / ... - check the windshield / note

PIN-GET-007 Scan vehicle barcode – scan the vehicle's barcode

PIN-GET-008 Show vehicle details – display the vehicle's details

PIN-GET-009 Perform 'Request Engine Start PIN' - perform 'requesting of the unlock PIN'

PIN-GET-010 Request: Engine Start PIN for VIN - request: unlock PIN for the VIN

PIN-GET-011 Check if vehicle status is 'RETURNED' - check whether the vehicle's status is "Returned"

PIN-GET-012 Return: Engine start PIN - return: unlock PIN

PIN-GET-013 Show Engine Start PIN - display the unlock PIN

VEH-HDL-001 Unlock vehicle - unlock the vehicle

VEH-HDL-002 Unlock vehicle - unlock the vehicle

VEH-HDL-003 Request vehicle unlock (remote services) – request unlocking of the vehicle (remote services)

VEH-HDL-004 Unlock vehicle - unlock the vehicle

VEH-HDL-005 Unlock doors - unlock the doors

VEH-HDL-006 Enter PIN via HMI – enter the unlock PIN using the human-machine interface (HMI)

VEH-HDL-007 Decrypt Immotoken with PIN – decrypt the immobilizer token with the unlock PIN

VEH-HDL-008 Decrement Attempt Counter - Reset on successful PIN input or condition - decrease the attempt counter - reset in the event of successful unlock PIN entry or condition

VEH-HDL-009 Block PIN Input for x Seconds - Blocked time duration increases for each wrong attempt, e.g. exponentially - block unlock PIN entry for x seconds - blocking time increases with every incorrect attempt, e.g. exponentially

VEH-HDL-010 Perform Engine Start - perform an engine start

S100 Method step

S200 Method step

S300 Method step

S400 Method step

S500 Method step

S600 Method step

S700 Method step

S101 Method step

S201 Method step

S301 Method step

S401 Method step

S501 Method step

What is claimed is:

1. A vehicle management arrangement, comprising:
a vehicle manufacturer backend device configured for generating, managing and distributing encrypted immobilizer tokens and unlock PINs, each immobilizer token being configured to release an immobilizer of a vehicle when a corresponding unlock PIN is entered,
a vehicle manager backend device configured for communication with the vehicle manufacturer backend device for receiving and forwarding the encrypted immobilizer tokens and the unlock PINs to a vehicle manager terminal;
a vehicle equipped with a control device for receiving the encrypted immobilizer tokens from the vehicle manufacturer backend device and/or the vehicle manager backend device, and for decrypting the immobilizer tokens after entry of the unlock PIN to release the immobilizer.

2. The vehicle management arrangement according to claim 1,
wherein
the control device of the vehicle is configured to immediately discard the decrypted immobilizer token and the unlock PIN after release of the immobilizer in order to prevent reuse of the unlock PIN.

3. The vehicle management arrangement according to claim 1,
wherein
the vehicle manufacturer backend device is configured to cyclically rotate the encrypted immobilizer tokens and/or the unlock PINs.

4. The vehicle management arrangement according to claim 1,
wherein
the control device of the vehicle is configured to communicate wirelessly with the vehicle manufacturer backend device and/or the vehicle manager backend device.

5. The vehicle management arrangement according to claim 1,
wherein
the vehicle remains enabled for a predetermined number of engine starts after entry of the unlock PIN.

6. The vehicle management arrangement according to claim 1,
wherein
the control device of the vehicle is configured to send status of the immobilizer to the vehicle manager backend device.

7. The vehicle management arrangement according to claim 6, wherein the status of the immobilizer includes status of the immobilizer token and of the unlock PIN.

8. The vehicle management arrangement according to claim 1, further comprising
a human-machine interface configured to display a current status of the immobilizer token.

9. The vehicle management arrangement according to claim 1,
wherein
the control device of the vehicle is configured to receive and implement wireless instructions for remotely locking and unlocking the vehicle using the vehicle manufacturer backend device and/or the vehicle manager backend device.

10. The vehicle management arrangement according to claim 1,
wherein
the vehicle manager backend device is configured to automatically send an encrypted immobilizer token to the vehicle after termination of a rental agreement pertaining to the vehicle in order to secure the vehicle until the next rental.

11. A vehicle management method for managing a vehicle, comprising:
generating, by a vehicle manufacturer backend device, encrypted immobilizer tokens and unlock PINs, each immobilizer token being configured to release an immobilizer of the vehicle when a corresponding unlock PIN is entered;
managing and distributing, by the vehicle manufacturer backend device, the encrypted immobilizer tokens and unlock PINs to a vehicle manager backend device;
forwarding the encrypted immobilizer tokens and unlock PINs from the vehicle manager backend device to a vehicle manager terminal;
receiving, by a control device of the vehicle, the encrypted immobilizer tokens from the vehicle manufacturer backend device and/or the vehicle manager backend device;
entering, by a user of the vehicle, the unlock PIN;
decrypting, by the control device, the immobilizer token after entry of the corresponding unlock PIN; and
releasing, by the control device, the immobilizer of the vehicle after successful decryption of the immobilizer token.
